(19) United States
(12) Patent Application Publication
(10) Pub. No.: US 2015/0288918 A1
(43) Pub. Date: Oct. 8, 2015

(54) METHOD AND DEVICE FOR ADAPTING A LINE FREQUENCY OF A DIGITAL SIGNAL OF A PROJECTION DEVICE

(71) Applicant: ROBERT BOSCH GMBH, Stuttgart (DE)

(72) Inventors: Frank Fischer, Gomaringen (DE); Alexander Ehlert, Schwaebisch Gmuend (DE); David Slogsnat, Tuebingen (DE); Gael Pilard, Wankheim (DE)

(21) Appl. No.: 14/437,221

(22) PCT Filed: Aug. 22, 2013
(86) PCT No.: PCT/EP2013/067469

§ 371 Date: Apr. 21, 2015

(30) Foreign Application Priority Data
Oct. 26, 2012 (DE) 10 2012 219 627.7

(51) Int. Cl. H04N 7/01; H04N 5/74; H04N 9/31

(52) U.S. Cl. CPC H04N 7/0122; H04N 7/0127; H04N 9/3188; H04N 5/7458

(57) ABSTRACT

A method for adapting a line frequency of a digital data signal of a projection device includes: providing data about at least one mechanical natural frequency of a mirror device of the projection device and about a storage capacity of a line buffer of an image processing device; detecting a first image resolution of a video signal of a video source device with the aid of the image processing device; and computing a second image resolution having an adapted vertical resolution of the digital data signal based on the detected first image resolution of the video signal as a function of the at least one mechanical natural frequency of the mirror device and the storage capacity of the line buffer with the aid of the image processing device to adapt the line frequency of the digital data signal of the projection device.

### BACKGROUND OF THE INVENTION

1. Field of the Invention

The present invention relates to a method and a system for adapting a line frequency of a digital signal of a projection device.

2. Description of the Related Art

US Patent Application Publication 2010 0128 169 A1 describes a frame rate converter and a method for projecting an image in HD standard. The frame rate converter described there is designed to convert frame rates for the purpose of projecting the image by storing a frame and by interpolating the stored frame.

US Patent Application Publication 2010 00 259 675 A1 describes a frame rate converting device for carrying out a frame rate conversion for image data having a different chronological image structure.

Published German patent DE 26 52 935 B2 describes a method for converting the frame rate in which signal sequences, each of which corresponds to an individual image or a partial image of an image sequence, are stored at a predetermined storage frequency and the stored signal sequences are converted into images or partial images at a playback frequency which is different from the storage frequency; signal sequences in a first memory device, the storage capacity of which is at least one image or partial image of the image sequence, are stored at a predetermined storage speed and are output at an increased output speed, i.e., in a time-compressed manner; and the signal sequences in a second storage device, the storage capacity of which also corresponds to at least one image or partial image of the image sequence, are stored at a predetermined signal sequence frequency and are output at an increased signal sequence frequency.

### BRIEF SUMMARY OF THE INVENTION

The present invention provides a method for adapting a line frequency of a digital signal of a projection device including the following method steps: providing data about at least one mechanical natural frequency of a mirror device of the projection device and about a storage capacity of a line buffer of an image processing device; detecting a first image resolution of a video signal of a video source device with the aid of the image processing device; and computing a second image resolution having an adapted vertical resolution of the data signal based on the detected first image resolution of the video signal as a function of the at least one mechanical natural frequency of the mirror device and the storage capacity of a line buffer with the aid of the image processing device for the purpose of adapting the line frequency of the digital signal of the projection device.

Furthermore, the present invention provides a system for adapting a line frequency of a digital signal of a projection device including: a video source device for providing a video signal having a first image resolution; an image processing device for detecting the first image resolution of the video signal of the video source device and for computing a second image resolution having an adapted vertical resolution of the data signal based on the detected first image resolution of the video signal as a function of at least one mechanical natural frequency of a mirror device and a storage capacity of a line buffer; and a projection device for projecting the digital signal at the line frequency of the digital signal adapted by the computation.

The idea of the present invention is to simplify the complex image data processing which is necessary for the frame rate conversion and to reduce the required buffer space. On the one hand, this results in a reduction of the costs originating from the manufacture and, on the other hand, of the power consumption occurring during operation. Moreover, the method according to the present invention for adapting a line frequency of a digital signal of a projection device does not reduce the ratio of the time in which pixels are projected by the projection device on the projection screen to the overall time.

The projection device is operated at a projection frequency which is advantageously adapted to the mechanical resonance frequencies of the MEMS micromirrors.

Although these settings are already advantageously set during manufacture, a deviation may occur due to aging and temperature effects.

Furthermore, inhomogeneities are compensated for which occur as a result of the adaptation to the mechanical resonance frequencies of the MEMS micromirrors during the manufacturing process as well as different effects of the video source, such as the pixel frequency or the blanking time.

The present invention uses an increased and adaptable number of displayed lines for the implementation of a complete frame rate. Here, the new image data having the increased number of displayed lines are accordingly computed by interpolating the original image data.

Another advantage of the present invention is that the number of displayed lines is computed dynamically during operation in order to compensate for device-specific effects using temperature or aging.

The most important advantage of this method is that the video source is able to work with the standard timing parameters while the synchronization of the clock rates within the projection device is taking place independently thereof.

Another advantage of the present invention is that no complete frame buffer or at least only a fraction of a frame buffer is needed as the image buffer for the purpose of buffering the non-synchronized video stream. This is an important contribution to reducing the system costs.

According to one specific embodiment of the present invention, it is provided that the storage capacity of the line buffer is adapted to a storage need of an image line of the video signal of the video source device. In this way, the storage need is also reduced for high image resolutions.

According to another specific embodiment of the present invention, it is provided that the data about the at least one mechanical natural frequency of the mirror device of the projection device and about the storage capacity of the line buffer are stored in a memory device of the image processing device. This makes the integration of the projection device into mobile communication devices or other portable electronic devices readily possible.

According to another specific embodiment of the present invention, it is provided that the computation of the second image resolution having the adapted vertical resolution is carried out based on the detected first image resolution of the video signal as a function of horizontal and/or vertical flyback times of the mirror device. This advantageously allows the down times of the projection device to be minimized.

According to another specific embodiment of the present invention, it is provided that the adaptation of the line frequency of the digital signal of the projection device is carried out by temporarily buffering an image line of the video signal of the video source device in the line buffer. With the aid of this specific embodiment, a desired adaptation of the clock rate may be carried out very effectively and reliably.

According to another specific embodiment of the present invention, it is provided that the adapted vertical resolution of the data signal is achieved by interpolating the first image resolution.

According to another specific embodiment of the present invention, it is provided that the provided data about the mechanical natural frequencies of the mirror device of the projection device are adapted to the temperature and/or age-related changes in the mirror device of the projection device.

Further features and advantages of specific embodiments of the present invention are derived from the following description, with reference to the attached drawing.

### BRIEF DESCRIPTION OF THE DRAWINGS

FIG. 1 shows a graphic representation of a flow chart of a method for adapting a line frequency of a digital signal of a projection device according to another specific embodiment of the present invention.

FIG. 2 shows a representation of a system for adapting a line frequency of a digital signal of a projection device according to another specific embodiment of the present invention.

FIG. 3 shows a schematic representation of different image resolution modes for comparing the projected image resolution with the transmitted image resolution according to another specific embodiment of the present invention.

### DETAILED DESCRIPTION OF THE INVENTION

In the figures of the drawing, elements, features, and components which are identical or have identical functions are each identified with identical reference numerals, unless otherwise indicated. It is furthermore understood that the components and elements in the drawings are not necessarily true to scale to one another for the sake of clarity and comprehensibility.

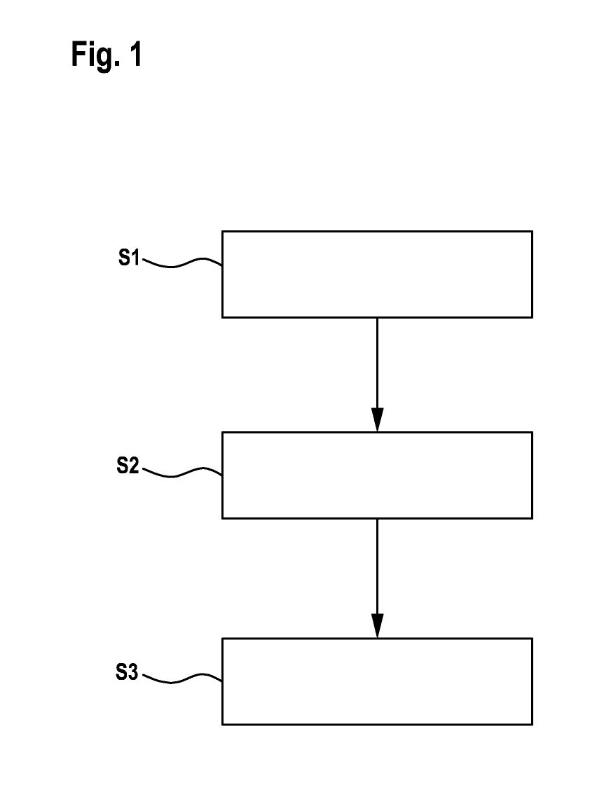

FIG. 1 shows a graphic representation of a flow chart of a method for adapting a line frequency of a digital signal of a projection device according to another specific embodiment of the present invention.

In a first step, a provision S1 of data takes place about at least one mechanical natural frequency of a mirror device SE of projection device PE and about a storage capacity of a line buffer ZP of an image processing device VDC.

In a second step, detection S2 of a first image resolution of a video signal VS of a video source device VE takes place with the aid of image processing device VDC.

In a third step, a computation S3 of a second image resolution having an adapted vertical resolution of data signal DP based on the detected first image resolution of video signal VS takes place as a function of the at least one mechanical natural frequency of mirror device SE and the storage capacity of a line buffer ZP with the aid of image processing device VDC for the purpose of adapting the line frequency of digital signal DP of projection device PE.

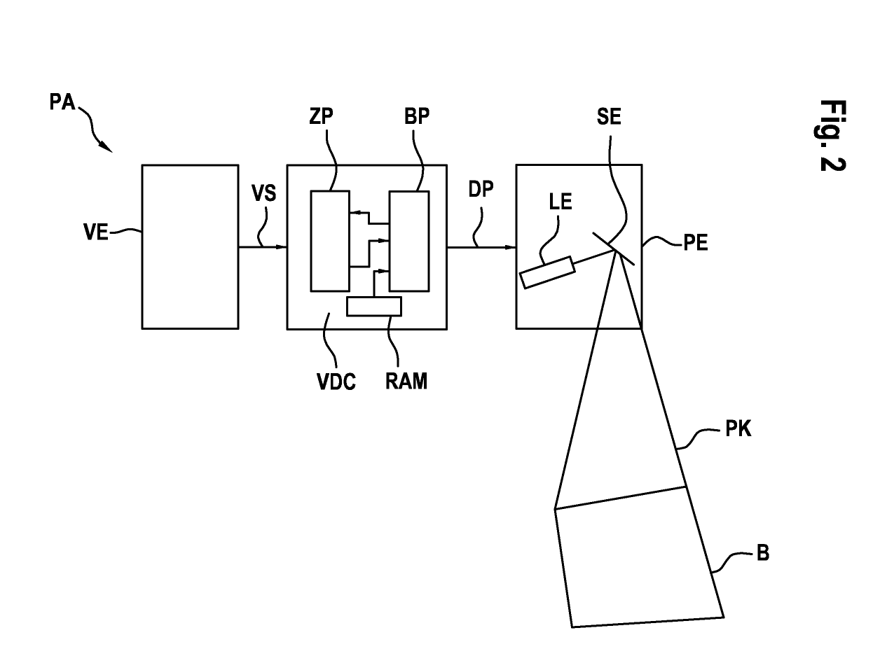

FIG. 2 shows a representation of a system for adapting a line frequency of a digital signal of a projection device according to another specific embodiment of the present invention.

A system PA for adapting a line frequency of a digital signal DP of a projection device PE includes a video source device VE, an image processing device VDC, and a projection device PE.

Projection device PE includes a laser device LE for generating a laser beam with the aid of which an image B is projected within a projection cone PK. In this case, the laser beam is periodically deflected in the horizontal and the vertical directions by a mirror device SE.

Image processing device VDC includes, for example, a memory device RAM, an image processor BP, and a line buffer ZP.

Image processing device VDC is furthermore coupled to video source device VE which is designed for providing a video signal VS having a first image resolution and a first clock rate.

Image processing device VDC is designed for detecting the first image resolution of video signal VS of video source device VE. Image processing device VDC is furthermore designed for computing a second image resolution having an adapted vertical resolution of data signal DP based on the detected first image resolution of video signal VS as a function of at least one mechanical natural frequency of mirror device SE and a storage capacity of a line buffer ZP.

Projection device PE is designed for projecting digital signal DP at the line frequency of digital signal DP adapted by the computation.

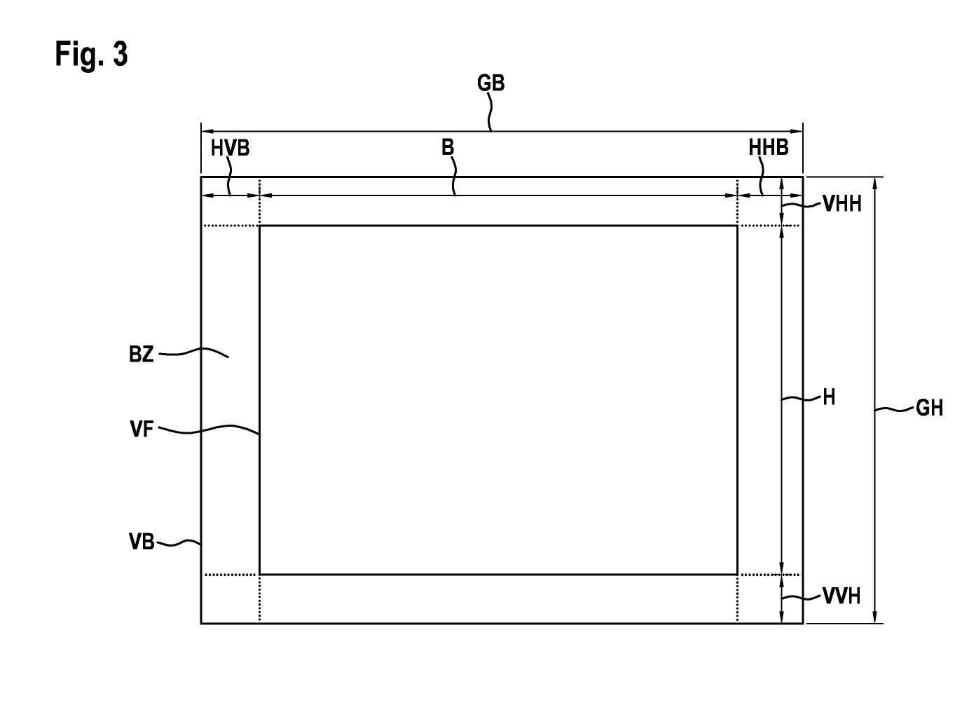

FIG. 3 shows a schematic representation of different image resolution modes for comparing the projected image resolution with the transmitted image resolution according to another specific embodiment of the present invention.

The area which is displayable by mirror device SE is defined by an overall width GB and an overall height GH of a virtual image area VB. A width B and a height H correspond to visible image area VF of projected image B. A horizontal front edge HVB and a horizontal rear edge HHB as well as a vertical front edge VVH and a vertical rear edge VHH form a non-projected dead area BZ.

Pixel clock rate f_{PXL} is computed from the product of width B and height H of image B as well as a frame rate fps of video signal VS of a video source device VE:

f_{PXL}=B·H·fps

In the case of an image B projected using system PA, this formula changes as follows by overall width GB and overall height GH to be projected:

f_{PXL}=GB·GH·fps

For this purpose, overall width GB and overall height GH are composed as follows:

GB=HVB+B+HHB

GH=VVH+H+VHH

A horizontal line frequency fₗᵢₙₑ of data signal DP is thus obtained by:

fₗᵢₙₑ=GB·fps

These computations apply to video source device VE as well as to projection device PE. Video source device VE has in this case a first line frequency. The projector has a second line frequency deviating therefrom. The greater the difference between the two line frequencies, the more storage space is needed. By interpolating the source resolution or the first image resolution to the projector resolution or to the second image resolution, an effective second line frequency is obtained. The closer this second line frequency is to the first line frequency, the smaller is the storage need.

The storage need of line buffer ZP is proportional to the difference between the first horizontal line frequency and the second horizontal line frequency.

With the aid of the method, the line frequencies of video signal VS and of data signal DP are also adapted in addition to the first and the second clock rates of video signal VS and data signal DP, an oversampling factor indicating the ratio of the particular line frequencies of video signal VS and of data signal DP.

The line frequencies of data signal DP are, for example, at the lower end of the tolerances of projection device PE.

For a static computation of the second image resolution and of the second clock rate as the clock rate of data signal DP, initially a definition of the video mode for a nominal mirror frequency takes place, subsequently a computation of the displayable vertical resolution takes place, and subsequently a variation of the mirror frequency of the second clock rate takes place, the buffer size of line buffer ZP being taken into consideration.

For a dynamic computation of the second image resolution and of the second clock rate as the clock rate of data signal DP, a detection of a frame time takes place, then a dynamic computation of the displayable vertical resolution takes place, and subsequently a compensation for the oversampling factor takes place.

1-10. (canceled)

11. A method for adapting a line frequency of a digital data signal of a projection device, comprising:
providing data about at least one mechanical natural frequency of a mirror device of the projection device and about a storage capacity of a line buffer of an image processing device;
detecting a first image resolution of a video signal of a video source device with the aid of the image processing device; and
computing, with the aid of the image processing device, a second image resolution having an adapted vertical resolution of the digital data signal based on the detected first image resolution of the video signal as a function of the at least one mechanical natural frequency of the mirror device and the storage capacity of a line buffer for the purpose of adapting the line frequency of the digital data signal of the projection device.

12. The method as recited in claim 11, wherein the storage capacity of the line buffer is adapted to a storage need of an image line of the video signal of the video source device.

13. The method as recited in claim 11, wherein the data about the at least one mechanical natural frequency of the mirror device of the projection device and about the storage capacity of the line buffer are stored in a memory device of the image processing device.

14. The method as recited in claim 11, wherein the computation of the second image resolution having the adapted vertical resolution is carried out based on the detected first image resolution of the video signal as a function of at least one of a horizontal flyback time and a vertical flyback time of the mirror device.

15. The method as recited in claim 11, wherein the adaptation of the line frequency of the digital data signal of the projection device is carried out by temporarily buffering an image line of the video signal of the video source device in the line buffer.

16. The method as recited in claim 11, wherein the adapted vertical resolution of the digital data signal is achieved by interpolating the first image resolution.

17. The method as recited in claim 11, wherein the provided data about the at least one mechanical natural frequency of the mirror device of the projection device is adapted to at least one of the temperature-related changes and age-related changes in the mirror device of the projection device.

18. A system for adapting a line frequency of a digital data signal of a projection device, comprising:
a video source device for providing a video signal having a first image resolution;
an image processing device for detecting the first image resolution of the video signal of the video source device and for computing a second image resolution having an adapted vertical resolution of the digital data signal based on the detected first image resolution of the video signal as a function of at least one mechanical natural frequency of a mirror device and a storage capacity of a line buffer; and
a projection device for projecting the digital data signal at the adapted line frequency of the digital data signal.

19. The system as recited in claim 18, wherein the image processing device of the system includes a memory device.

20. The system as recited in claim 18, wherein the mirror device is a micromirror device.
